(19) United States
(12) Patent Application Publication
(10) Pub. No.: US 2004/0139324 A1
(43) Pub. Date: Jul. 15, 2004

(54) Apparatus and method for preventing forgery/alteration of the data recorded by digital voice recorder

(76) Inventors: Dong-Hwan Shin, Seoul (KR); Jin-Ho Yoon, Seoul (KR); Young-Ho Choi, Inchon (KR); Jong-Uk Choi, Seoul (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/685,881

(22) Filed: Oct. 14, 2003

(30) Foreign Application Priority Data
Oct. 15, 2002 (KR) 2002-62768

(51) Int. Cl. H04L 9/00

(52) U.S. Cl. 713/176; 380/252

(57) ABSTRACT

The present invention discloses an apparatus for authentication, prevention of forgery/alteration of data recorded by digital voice recorder (DVR) and method thereof. A forgery or alteration prevention unit is installed inside the digital voice recorder or inside the PC connected to the digital voice recorder. The forgery or alteration prevention unit goes through a process to prevent forgery/alteration before audio data is recorded by the digital voice recorder or before audio data is stored at the data storage unit inside the PC. This can be performed by embedding watermark into audio data, by encrypting audio data by a predetermined encryption key, or by inserting a hash value into the audio data. Accordingly, forgery/alteration of audio data recorded by digital voice recorder can be verified.

### CROSS-REFERENCE TO RELATED APPLICATIONS

The present patent application claims priority from Republic of Korea Patent Application No. 2002-62768, filed on Oct. 15, 2002.

1. Field of the Invention

The present invention relates to an apparatus and method for preventing forgery/alteration of the data recorded by digital voice recorder (DVR). More particularly, it relates to an apparatus and method preventing forgery/alteration of recorded data by going through a predetermined process using the forgery or alteration prevention unit on data recorded by a digital voice recorder.

2. Description of the Related Art

Digital voice recorder is an apparatus recording data on a recording medium such as flash memory, DAT, audio tape by transforming voice, sound, and other noises into digital signals.

FIG. 1 is a block diagram illustrating the constitution of a conventional digital voice recorder.

Referring to FIG. 1, a digital voice recorder 100 comprises a microphone 101, input signal controller 102, A/D converter 103, CPU or micro-controller 104, D/A converter 105, output signal controller 106, speaker or headphone 107, data compressor/de-compressor 110, data storage unit 111 and data transmitter 109, and it can be connected to the Personal Computer (PC) 108 by the data transmitter 109 in accordance with users need.

An input audio signal from the microphone 101 is controlled to fit in the movement range of the A/D converter 103 at the input signal controller. The input analog audio signal is converted into digital audio signal at the A/D converter 103. The CPU or micro-controller 104 controls all operation of the DVR. The micro-controller 104 is a chip running a program for performing the operation of the DVR, independently, by building a program ROM, data RAM, CPU inside it.

Data compressor/de-compressor 110 stores digital audio data at the data storage unit 111 after compressing digital audio data or decompresses the compressed digital data at the data storage unit 111. Output signal controller 106 controls the range of the signal so that the analog audio signal converted by the D/A converter 105 fits the input of the speaker or headphone. The speaker or headphone 107 outputs the stored audio signal outside the digital voice recorder.

Meanwhile, data transmitter 109 is used to transmit the data recorded by the digital voice recorder to the PC. The data transmitter 109 is an apparatus implementing a communication means connecting the PC comprising serial communication (RS-232, UBS, IEEE1394, etc.), parallel communication (PC parallel port communication: SPP, ECP, EPP, etc.), etc. to the digital voice recorder. The PC 108 receives the data recorded by the digital voice recorder 100. The connection of the power supply 112 is not shown in the figures in detail, but the power supply 112 supplies power to the above devices, which can be implemented by battery or AC-DC converter.

A brief description of the operation of the above digital voice recorder 100 is as follows; first, outer audio signal is concerted into electronic signal by the microphone 101, and controlled to fit in the input range of the A/D converter 103 at the input signal controller 102. The controlled audio signal is converted into digital audio signal by the A/D converter 103. In order to record audio signal, the converted digital audio signal is compressed by the data compressor/de-compressor and then stored at the data storage unit 111 by the CPU or micro-controller 104.

In order to play the audio signal recorded by the digital voice recorder 100, the audio signal stored at the data storage unit 111 is decompressed at the data compressor/de-compressor 110, and then converted into analog signal at the D/A converter 105. The output signal controller 106 converts the converted analog audio signal into a signal with proper range so that it can be output through a speaker or headphone.

Also, in order to transmit the audio signal to the PC 108, as in the steps for playing the audio signal, it is decompressed at the data storage unit 111 by a data compressor/de-compressor 110, and then transmitted to the PC 108 by a data transmitter 109.

The above-described digital voice recorder is mainly used when it is required to record a conversation. For example, it can be used to record the contents of a conference, which may lead to a dispute later, such as a client's order information on selling or buying stock at a stock company.

However, because there is distrust on the message recorded by the digital voice recorder, which is raised by the distrust between the party possessing the digital voice recorder and the opposite party, and because the recorded audio data can be forged or altered without trouble, a security solution which can prevent forgery/alteration of such recorded audio data is strongly needed.

In this regard, there were no countermeasures to prevent forgery/alteration of audio data recorded by digital voice recorder in the past. Especially, since the authority for controlling the digital voice recorder is concentrated on one side of the party, there is a high possibility to dispute its authentication with the other party.

### SUMMARY OF THE INVENTION

In order to overcome the above problems, the present invention provides an apparatus and method for preventing forgery/alteration of the data recorded by the digital voice recorder, i.e., a watermark embedding unit, encryption unit or hash value inserting unit which can authenticate forgery/alteration of the data later.

Accordingly, the present invention provides an apparatus and method for authenticating whether the recorded data has been forged/altered when the data is recorded by a digital voice recorder or transmitted to the PC after being recorded at a digital voice recorder, by using a technology which can prevent or authenticate forgery/alteration of data in real-time when data is recorded by the digital voice recorder or when data is transmitted to the PC from the digital voice recorder.

In order to accomplish the above object, the present invention provides a forgery or alteration prevention apparatus for inserting an information for preventing forgery or alteration of an audio data into the audio data which is stored in DVR (Digital Voice Recorder), said DVR comprises an audio data input unit, A/D converter converting an analog audio data from said audio data input unit into a digital audio data, and a data storage unit storing said digital audio data, wherein said forgery or alteration prevention apparatus receives said digital audio data from said A/D converter, and inserts said information for preventing forgery or alteration into said digital audio data before storing said digital audio data in said data storage unit.

Preferably, said apparatus is implemented within the digital voice recorder in the form of general PCB board, DSP chip board, FPGA (Flexible Program Gate Array) board, ASIC (Application Specific Integrated Circuit) board, or software programs.

Further, in a system for receiving a digital audio data stored in DVR and storing said digital audio data in PC, a forgery or alteration prevention apparatus for inserting an information for preventing forgery or alteration of said digital audio data, wherein said forgery or alteration prevention apparatus is provided in said PC, and inserts said information for preventing forgery or alteration into said digital audio data before storing said digital audio data in a data storage unit in said PC.

In accordance with the first embodiment of the invention, the insertion of said information for preventing forgery or alteration is carried out by embedding watermark into said digital audio data, and the confirmation of whether said stored digital audio data has been forged or altered is carried out by detecting said watermark.

Preferably, said watermark is one of robust watermark or semi-fragile watermark, and the embedment of said watermark is carried out before the compression of said digital audio data.

Preferably, said watermark is fragile watermark; and the embedment of said watermark is carried out after the compression of said digital audio data.

In accordance with the second embodiment of the invention, the insertion of said information for preventing forgery or alteration is carried out by encrypting said digital audio data by predetermined encryption key.

In accordance with the first embodiment of the invention, the insertion of said information for preventing forgery or alteration is carried out by inserting hash value of said digital audio data into said digital audio data, and the confirmation of whether said stored digital audio data has been forged or altered is carried out by confirming whether the hash value newly obtained by applying said stored digital audio data to a hash function used for obtaining said hash value is identical to the hash value inserted in said stored digital audio data.

In order to accomplish the other object of the present invention, the present invention provides a method for inserting an information for preventing forgery or alteration of an audio data stored in DVR, said DVR comprises an audio data input unit, A/D converter converting an analog audio data from said audio data input unit into a digital audio data, and a data storage unit storing said digital audio data, the method comprising: (a) receiving said digital audio data from A/D converter; (b) inserting said information for preventing forgery or alteration into said digital audio data in real time; and (c) storing said digital audio data into which said information for preventing forgery or alteration is inserted in said data storage unit.

Meanwhile, the present invention provides a method for inserting an information for preventing forgery or alteration into said received digital audio data in said PC in a system for receiving a digital audio data stored in DVR and storing said digital audio data in PC, the method comprising: (a) receiving said digital audio data stored in said DVR; (b) inserting said information for preventing forgery or alteration into said digital audio data in real time; and (c) storing said digital audio data into which said information for preventing forgery or alteration is inserted in said PC.

In accordance with the first embodiment of the present invention, said step (b) is carried out by embedding watermark into said digital audio data, and the confirmation of whether said stored digital audio data has been forged or altered is carried out by detecting said watermark.

In accordance with the second embodiment of the present invention, said step (b) is carried out by encrypting said digital audio data with a predetermined encryption key.

In accordance with the third embodiment of the present invention, said step (b) is carried out by inserting hash value of said digital audio data into said digital audio data, and the confirmation of whether said stored digital audio data has been forged or altered is carried out by confirming whether hash value inserted in said digital audio data is identical to the newly obtained hash value from applying said stored digital audio data to the hash function used for obtaining said hash value.

### BRIEF DESCRIPTION OF THE DRAWINGS

FIG. 1 is a block diagram illustrating the constitution of a conventional digital voice recorder;

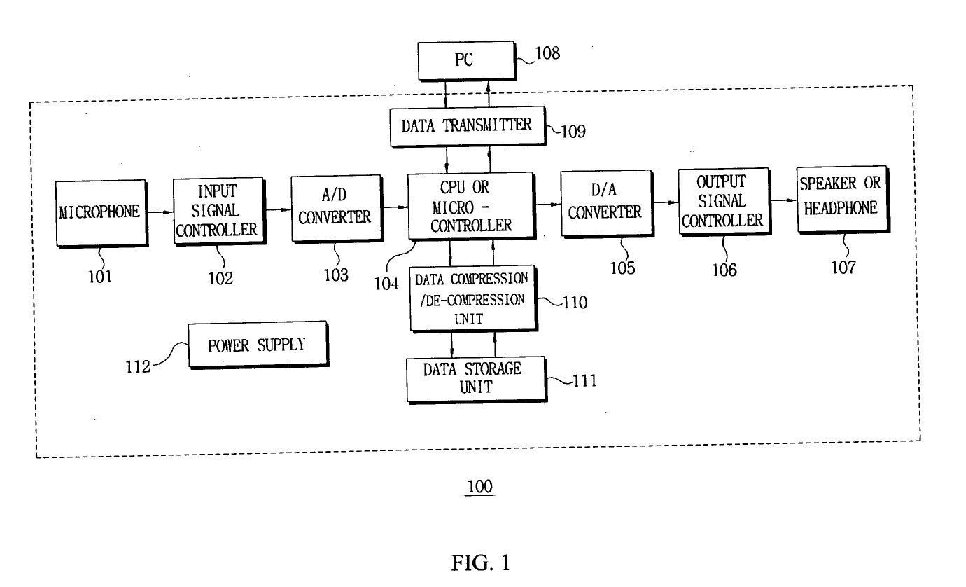

FIG. 2 is a block diagram illustrating the constitution of a digital voice recorder wherein the forgery/alteration prevention unit in accordance with the present invention is installed outside the recorder;

FIG. 3 is a block diagram illustrating the constitution of a digital voice recorder wherein the forgery/alteration prevention unit in accordance with the present invention is installed inside the recorder;

FIG. 4a is a drawing illustrating the embedding and detecting process of the watermark in accordance with the first embodiment of the present invention;

FIG. 4b is a block diagram illustrating the constitution of the watermark-embedding unit in accordance with the first embodiment of the present invention;

FIG. 5a is a drawing illustrating the encryption and decryption process in accordance with the second embodiment of the present invention;

FIG. 5b is a block diagram illustrating the constitution of the encryption unit in accordance with the second embodiment of the present invention;

FIG. 6a is a drawing illustrating the data authenticating process using hash function in accordance with the third embodiment of the present invention; and

FIG. 6b is a drawing illustrating the constitution of the hash value-inserting unit in accordance with the third embodiment of the present invention.

### DETAILED DESCRIPTION OF THE PREFERRED EMBODIMENTS

Hereinbelow, the preferred embodiments of the present invention are described in more detail in the following with reference to the accompanied drawings.

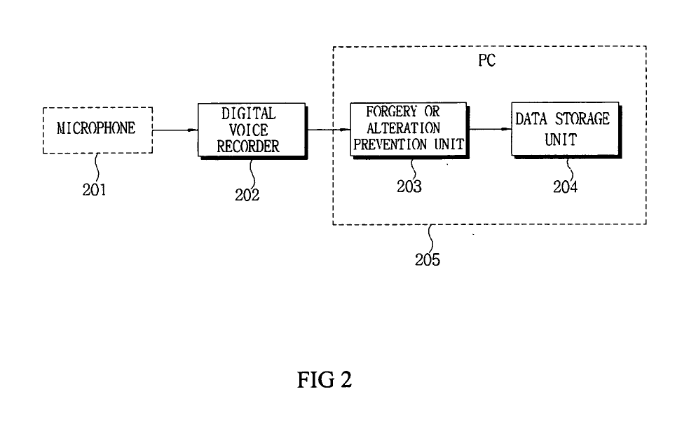

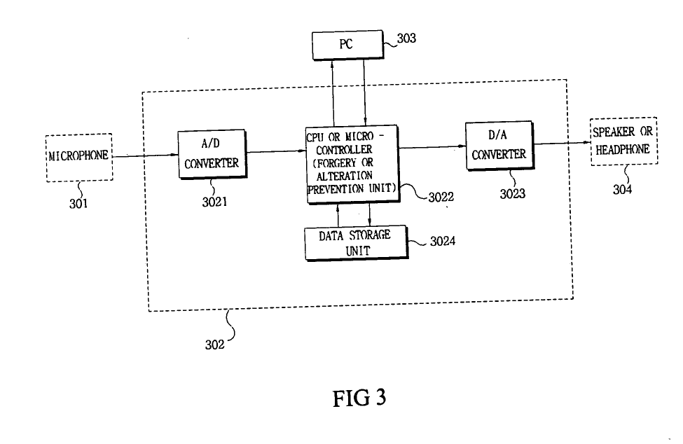

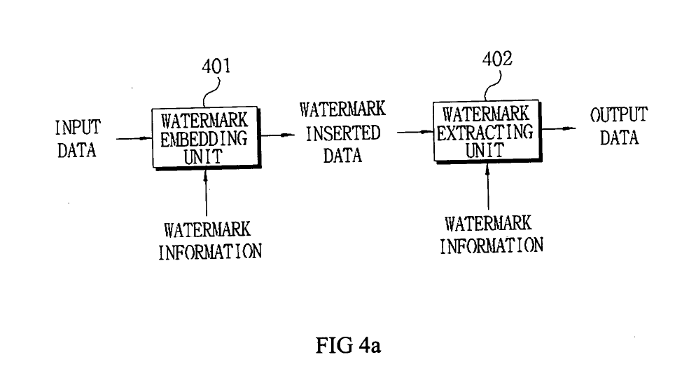

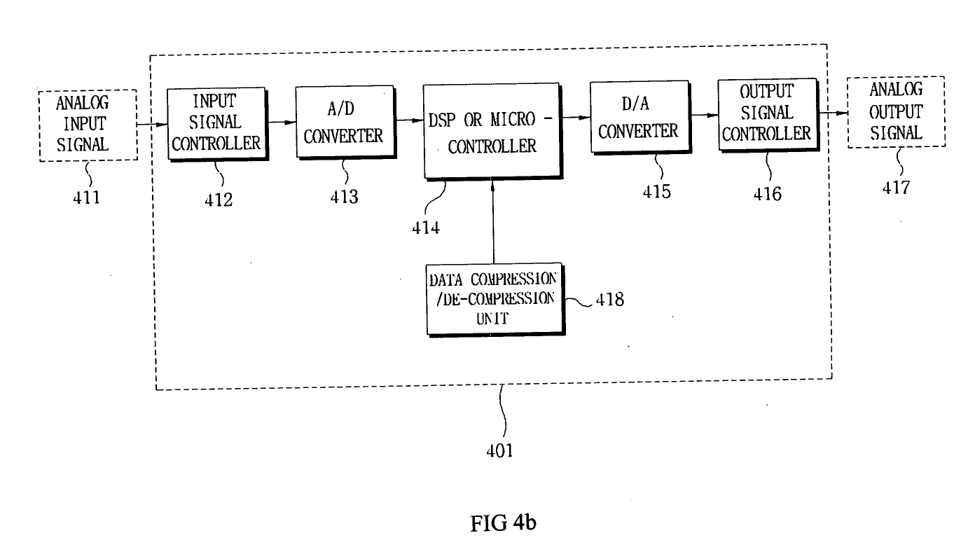

First, the constitution of the forgery/alteration prevention unit in accordance with the present invention (more particularly, the forgery/alteration prevention unit may be a watermark embedding unit, an encryption unit, or a hash value inserting unit, which will be described in more detail in the following with reference to FIGS. 4 to 6) wherein various embodiments of the digital voice recorder are applied will be described with reference to FIG. 2 and FIG. 3.

FIG. 2 is a block diagram illustrating the constitution of a digital voice recorder wherein the forgery/alteration prevention unit in accordance with the present invention is installed outside DVR.

Referring to FIG. 2, the forgery or alteration prevention unit 203 is installed inside the PC 205, and a forgery/alteration prevention means is inserted into the data received from the digital voice recorder 202. As for a more detailed description on the operation of the forgery or alteration prevention unit 203, first an audio signal is input from the microphone 201. The input audio signal is converted into digital and recorded by the digital voice recorder 202. Then, said audio signal is stored permanently or uploaded to the PC 205 by the data transmitter 109 if needed. At this time, a predetermined forgery or alteration prevention means is inserted by the forgery or alteration prevention unit 203 installed in the PC 205. The forgery or alteration prevention unit 203 is the unit wherein inserts information for authentication into the data to be recorded and the inserted information can be used when determining whether the recorded data is forged/altered later. Then, the audio data is stored in a predetermined storage medium (data storage unit 204) such as a hard disc drive inside the PC 205.

Said forgery or alteration prevention unit 203 may be a watermark embedding unit, an encryption unit, or a hash value inserting unit, and description thereof will be described in more detail in the following with reference to FIGS. 4 to 6.

FIG. 3 is a block diagram illustrating the constitution of a digital voice recorder wherein the forgery/alteration prevention unit in accordance with the present invention is installed inside the recorder.

Referring to FIG. 3, information for preventing forgery/alteration is inserted into said audio signal at the forgery or alteration prevention unit 302 before the audio signal received from the microphone 301 is converted into and stored in the data storage unit 204 of the digital voice recorder 302. Then, the audio signal is transmitted to the PC 303, and may be stored in the PC 303 as well.

In FIG. 3, the forgery or alteration prevention apparatus 3022 installed inside the digital voice recorder according to the present invention is implemented to carry out its operation at CPU or micro-controller 104, but a person skilled in the art may also embody the forgery or alteration prevention apparatus 3022 as a separate individual device.

The forgery or alteration prevention apparatus 3022 installed inside the digital voice recorder may be a watermark embedding unit, an encryption unit, or a hash value inserting unit, and the description thereof will be made in reference to FIGS. 4 to 6 hereinafter.

The forgery or alteration prevention apparatus 203, 3022 of FIGS. 2 & 3 can be implemented in the form of an general PCB board, a DSP chip board, an FPGA (Flexible Program Gate Array) board, an ASIC (Application Specific Integrated Circuit) board, or software programs.

The specific forgery or alteration prevention technology and the internal constitution of forgery or alteration prevention apparatus 203, 3022 according to the first, second and third preferred embodiments of the present invention used in the aforementioned forgery or alteration prevention apparatus 203, 3022 are described hereinafter.

The first embodiment of the present invention is the embodiment of the forgery or alteration prevention apparatus according to the method of watermarking.

FIG. 4a is a drawing illustrating embedment and detection process of the watermark according to the first embodiment of the present invention.

Referring to FIG. 4a, the watermark-embedding unit 401 embeds watermark into the input audio signals. The embedded watermark information is the information verifying the authenticity of the audio data later. The watermark-embedding unit 401 refers to the aforementioned forgery or alteration prevention apparatus of the present invention. Hereinafter, the audio data inserted with watermark is stored in the storage unit, thereby the process of inserting information for preventing forgery or alteration according to the present invention is completed.

The types of watermark usable in the present embodiments include Robust Watermark (RW), Semi-Fragile Watermark (SFW), and Fragile Watermark (FW), and watermark is also classified according to the extent of how much the watermark endures against the external attack or alteration.

The robust watermark refers to watermark capable of extracting watermark information even at the attack such as compression and A/D conversion, noise addition, etc. The semi-fragile watermark is characterized in that the watermark remains intact against the attack such as compression, but the watermark will break down against the malicious attack such as alteration of the audio data. The fragile watermark is characterized in that the watermark will break down even at the slight alteration. Thus, if using a fragile watermark in the present invention, watermark should be embedded after the compression of the audio data when compressing and storing data.

Although FIG. 4a illustrates as a continuous process, it is general for the audio data embedded with watermark in the forgery or alteration prevention apparatus according to the present invention when it becomes a matter of concern whether the data has been forged or altered that the process of extracting watermark is carried out from the separate off-line watermark extracting unit (may be a software program embodied in PC). The extraction of the watermark may be certification of the information embedded as watermark itself, and also it is possible to check whether audio date stored has been forged or altered with respect to whether the watermark has been broken down.

FIG. 4b is a block diagram illustrating the constitution of the watermark-embedding unit according to the first embodiment of the present invention. That is, the forgery or alteration prevention apparatus of FIGS. 2 & 3 is implemented as a watermark-embedding unit according to the first embodiment of the present invention.

Referring to FIG. 4b, the watermark-embedding unit 401 according to the first embodiment of the present invention comprises an input signal controller 412, an analog-digital converter 413, a digital signal processor or a micro-controller 414, a digital-analog converter 415, an output signal controller 416, and a power supplying unit 418.

The input signal controller 412 adjusts the analog input signals 401 (audio signals) input from the aforementioned microphone to satisfy the input range of the A/D converter 413. The adjusted analog audio signals are converted to digital audio signals by the A/D converter 413.

The converted audio signals are inserted with watermark at the digital signal processor or micro-controller 414, and the audio signals embedded with watermark are converted again to analog signals (i.e., audio signals) at the D/A converter 415, then the analog signals embedded with watermark is adjusted into a predetermined range at the output signal controller 416 so as to be output analog output signals 417. Meanwhile, the power supply 418 supplies necessary power to a digital signal process or micro-controller 414.

Meanwhile, if the desired watermark is the robust watermark or semi-fragile watermark, it is desirable to carry out embedment of watermark before the converted digital audio data is compressed. Generally, if the desired watermark is the fragile watermark, it is desirable to carry out the embedment of watermark after the converted digital audio data is compressed.

The second embodiment of the present invention is the implementation of the forgery or alteration prevention apparatus according to the use of an encryption algorithm.

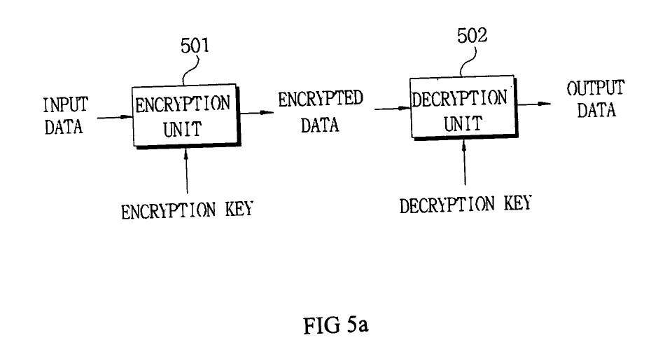

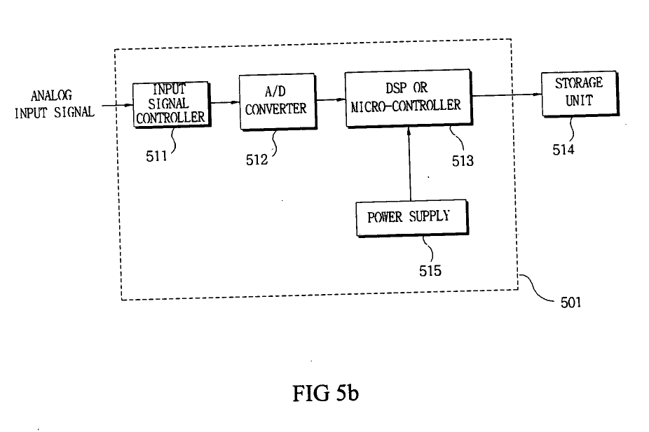

FIG. 5a is a drawing illustrating an encryption and decryption process in accordance with the second embodiment of the present invention.

Referring to FIG. 5a, the encryption unit 501 encrypts the inputted audio data by a predetermined encryption algorithm. In this regard, a predetermined encryption key is used in the encryption. The encrypted data is stored in the data storage unit (not shown).

If the audio data is encrypted by the predetermined encryption key at the forgery or alteration prevention apparatus according to the present invention, it is possible to confirm whether the stored audio data has been forged or altered by carrying out the decryption process to the encrypted data at the separate off-line decryption unit (it may be a software program embodied in PC) when the alteration or forgery of the later data becomes a matter of concern. The types of the encryption system according the preferred embodiment of the present invention include symmetric cryptosystem (may also be called ‘public key encryption system’) and asymmetric cryptosystem (may also be called ‘secret key encryption system’). In the symmetric encryption system, the encryption key is the same as the decryption key, but in the asymmetric encryption system, the encryption key is different from the decryption key.

The symmetric encryption algorithm is characterized in that the speed of encryption and decryption is fast, which includes DES, 3DES, SEED and Rijndael, etc. The asymmetric encryption algorithm is characterized in that it is difficult to solve mathematically and it takes long to decrypt, which includes RSA, E1Gamal, and ECC, etc. It does not matter for the present invention to use any of the encryption algorithm.

The preferred embodiment of the present invention uses Rijndael algorithm of 128 bits adopted as AES (Advanced Encryption Standard) by NIST of U.S. and conducted the experiment, and the result of the experiment is as follows. Such result of the experiment refers to resource required to make Raw Data decrypted into 256 bytes from the data encrypted into 256 bytes when implementing Rijndael algorithm by using TI DSP (TI Digital Signal Processor) of U.S.

Resource used when decrypting at TI DSP (TMS 320VC5410): 256 bytes

Capacity of operation: approximately 20 MIPS (Million Instruction Per Second)

Size of the program code memory used for decryption at TI DSP: 10 KB (10,714 bytes)

Size of the data memory used for decryption at TI DSP: 1KB (1,024 bytes)

FIG. 5b is a block diagram illustrating the constitution of the encrypting unit in accordance with the second embodiment of the present invention. Unlike FIG. 4b, the digital signal processor or micro-controller 513 does not carry out the function of embedding watermark, but carries out the function of encrypting digital audio data by using encryption key. Otherwise, the same description made with regard to FIG. 4b is applied.

The third embodiment of the present invention is implementation of the forgery or alteration prevention apparatus using a hash function.

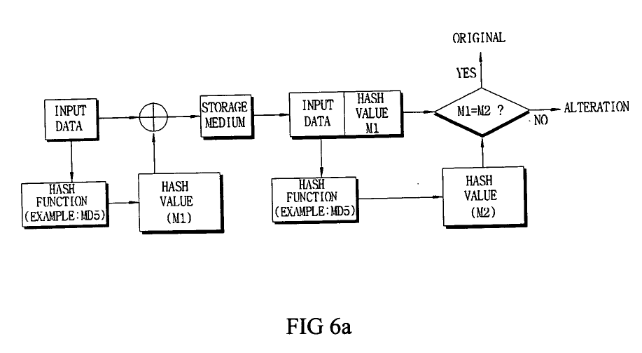

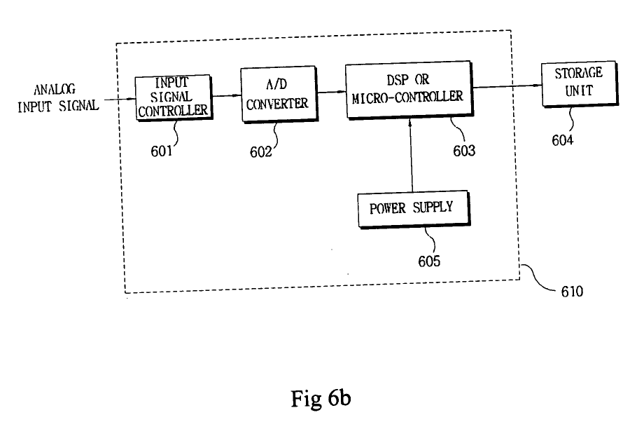

FIG. 6a is a drawing illustrating the data authentication process using hash function in accordance with the third embodiment of the present invention.

Referring to FIG. 6a, the inputted audio data is input in the hash function, which can be indicated as Equation 1 as below. It is desirable to use MD5 (Message Digest 5) as the usable hash function, however, it is not limited thereto.

M₁=H(I) [Equation 1]

Herein, I is the input data, H(x) is the hash function, and M₁ is the calculated hash value.

The hash value M₁ which is the output value of the hash function is inserted in the input audio data, and the audio data is stored in the storage medium in a state wherein the hash value M₁ is inserted.

The characteristic of the hash function is that it is a one-way function. That is, it is impossible to infer the input data inputted in the hash function only with the hash value.

When the audio data inserted with the hash value calculated by a predetermined hash function at the forgery or alteration prevention apparatus according to the present invention has a problem of whether the data is forged or altered later, the verification process of the hash value is carried out at the separate off-line hash value verification unit (it may be a software program implemented in PC) and thus it is possible to confirm whether the stored audio data is forged or altered.

The specific process of verifying a hash value is as follows. The stored audio data is comprised of the input audio data itself and the calculated hash value M₁ by applying the hash function to the data. A new hash value M₂ is obtained by using a hash function identical to that used for input data at the hash value-inserting unit (that is, the forgery or alteration prevention apparatus according to the present invention). If the hash value M₁ inserted into the stored audio data is identical to the newly obtained hash value M₂, the stored audio data is the original data which has not been forged or altered. If the two hash values M₁ and M₂ are different from each other, the stored audio data is considered to be forged or altered.

FIG. 6b is a drawing illustrating the constitution of the hash value-inserting unit in accordance with the third embodiment of the present invention. Unlike FIG. 4b, the digital signal processor or micro-controller 513 does not carry out the function of embedding watermark, but calculates the hash value with regard to the digital audio data and carries out the function of inserting the calculated hash value into the specific portion of the audio data. Otherwise, the same description made with regard to FIG. 4b is applied.

The aforementioned present invention provides an effect of confirming whether the stored audio data is forged or altered when it is necessary to confirm the stored audio data by using a technology preventing or confirming the forgery or alteration of the data in real-time when recording conversation data on the digital voice recorder (DVR).

The present invention has been described specially by illustration with reference to the above embodiments, but such description is made for exemplification, and a person having ordinary skill in the art to which the present invention pertains is aware that he may variously change without deviating from the technical idea and scope of the present invention as defined in the accompanied claims.

What is claimed:

1. A forgery or alteration prevention apparatus for inserting an information for preventing forgery or alteration of an audio data into the audio data which is stored in DVR (Digital Voice Recorder), said DVR comprises an audio data input unit, A/D converter converting an analog audio data from said audio data input unit into a digital audio data, and a data storage unit storing said digital audio data,
wherein said forgery or alteration prevention apparatus receives said digital audio data from said A/D converter, and inserts said information for preventing forgery or alteration into said digital audio data before storing said digital audio data in said data storage unit.

2. In a system for receiving a digital audio data stored in DVR and storing said digital audio data in PC, a forgery or alteration prevention apparatus for inserting an information for preventing forgery or alteration of said digital audio data,
wherein said forgery or alteration prevention apparatus is provided in said PC, and inserts said information for preventing forgery or alteration into said digital audio data before storing said digital audio data in a data storage unit in said PC.

3. A forgery or alteration prevention apparatus according to claim 1, wherein the insertion of said information for preventing forgery or alteration is carried out by embedding watermark into said digital audio data, and
the confirmation of whether said stored digital audio data has been forged or altered is carried out by detecting said watermark.

4. A forgery or alteration prevention apparatus according to claim 1, wherein the insertion of said information for preventing forgery or alteration is carried out by encrypting said digital audio data by predetermined encryption key.

5. A forgery or alteration prevention apparatus according to claim 1, wherein the insertion of said information for preventing forgery or alteration is carried out by inserting hash value of said digital audio data into said digital audio data, and
the confirmation of whether said stored digital audio data has been forged or altered is carried out by confirming whether the hash value newly obtained by applying said stored digital audio data to a hash function used for obtaining said hash value is identical to the hash value inserted in said stored digital audio data.

6. A forgery or alteration prevention apparatus according to claim 1, wherein said apparatus is implemented within the digital voice recorder in the form of general PCB board, DSP chip board, FPGA (Flexible Program Gate Array) board, ASIC (Application Specific Integrated Circuit) board, or software programs.

7. A forgery or alteration prevention apparatus according to claim 3, wherein said watermark is one of robust watermark or semi-fragile watermark, and
the embedment of said watermark is carried out before the compression of said digital audio data.

8. A forgery or alteration prevention apparatus according to claim 3, wherein said watermark is fragile watermark; and
the embedment of said watermark is carried out after the compression of said digital audio data.

9. A method for inserting an information for preventing forgery or alteration of an audio data stored in DVR, said DVR comprises an audio data input unit, A/D converter converting an analog audio data from said audio data input unit into a digital audio data, and a data storage unit storing said digital audio data, the method comprising:
(a) receiving said digital audio data from A/D converter;
(b) inserting said information for preventing forgery or alteration into said digital audio data in real time; and
(c) storing said digital audio data into which said information for preventing forgery or alteration is inserted in said data storage unit.

10. In a system for receiving a digital audio data stored in DVR and storing said digital audio data in PC, a method for inserting an information for preventing forgery or alteration into said received digital audio data in said PC, the method comprising:
(a) receiving said digital audio data stored in said DVR;
(b) inserting said information for preventing forgery or alteration into said digital audio data in real time; and
(c) storing said digital audio data into which said information for preventing forgery or alteration is inserted in said PC.

11. A method according to claim 9, wherein said step (b) is carried out by embedding watermark into said digital audio data, and
the confirmation of whether said stored digital audio data has been forged or altered is carried out by detecting said watermark.

12. A method according to claim 9, wherein said step (b) is carried out by encrypting said digital audio data with a predetermined encryption key.

13. A method according to claim 9, wherein said step (b) is carried out by inserting hash value of said digital audio data into said digital audio data, and
the confirmation of whether said stored digital audio data has been forged or altered is carried out by confirming whether hash value inserted in said digital audio data is identical to the newly obtained hash value from applying said stored digital audio data to the hash function used for obtaining said hash value.
